(19) United States
(12) Patent Application Publication
(10) Pub. No.: US 2011/0170924 A1
(43) Pub. Date: Jul. 14, 2011

(54) System and Method for Populating and Printing Paper Ballots

(75) Inventor: McDermot Shafer Coutts, San Diego, CA (US)

(73) Assignee: International Lottery and Totalizator Systems, Inc, Vista, CA (US)

(21) Appl. No.: 12/965,581

(22) Filed: Dec. 10, 2010

Related U.S. Application Data
(60) Provisional application No. 61/285,625, filed on Dec. 11, 2009.

(51) Int. Cl. B41J 11/44

(52) U.S. Cl. 400/76

(57) ABSTRACT

Systems and methods for populating and printing paper ballots are provided. The system includes a voter interface module configured to receive a voter selection of options from a list of options on a voter interface and a ballot definition module configured to create a ballot definition which associates each option on a ballot with a respective position on a two dimensional grid. A ballot generation module uses the ballot definition module to determine the position for each option selected by the voter and controls a printer to print a paper ballot having a two dimensional, machine readable grid with markings at the determined positions corresponding to the voter selected options received at the voter interface module.

### RELATED APPLICATION

The present application claims priority to U.S. provisional patent application ser. no. 61/285,625 filed 11 Dec. 2010, which is incorporated herein by reference in its entirety.

### BACKGROUND

1. Field of the Invention

The present invention is generally related to conducting elections and more specifically related to a system and method for creating and scanning paper ballots used in an election.

2. Related Art

Current legislation requires that all voting systems use a paper ballot for recording or verifying a voter's selections. Devices currently in use show several different approaches. One common approach is the printing of a viewable receipt of the voters selections based on voter input, which is commonly referred to as Voter Verified Paper Audit Trail (“VVPAT”), that can be associated with an electronic record or can be hand counted for verification, which is a time and resource intensive operation. Alternately, optical scan systems allow for the voter to mark a pre-printed ballot paper ballot which is subsequently interpreted by a scanner. Optical Scan systems are subject to an inconsistency of selection marks by the voter, which can hamper accuracy and by the fact that the ballots are limited to a single format enforced by the scanning system. Therefore, what is needed is a system and method that overcomes these significant problems found in the conventional systems as described above.

### SUMMARY

This invention provides a flexible structure for defining a ballot by assigning each candidate a physical position in a two dimensional grid. In one embodiment, the voter is presented with an interface to make the desired selections from a list of ballot options. These selections are printed (with or without associated textual elements) on a paper ballot as markings at predetermined positions in the grid which can be read and interpreted by a scanning device. The ballot additionally contains tags which identify which grid definition is used to interpret the results. These tags can include, but are not limited to, text that can be interpreted by Optical Character Recognition (OCR) algorithms, barcodes including two dimensional, three dimensional, and any other sort of bar code that can be read and interpreted by a barcode reader, orientation marks and scale marks.

In one embodiment, a computer implemented method for populating and printing paper ballots is provided, where one or more processors are programmed to perform steps comprising:

assigning each option of a series of voter selectable options with a respective position on a two dimensional grid;

creating a grid definition comprising a list of the voter selectable options and the associated grid positions;

storing the grid definition in a memory; receiving data from a voter comprising a selection of options from a list of voter selectable options;

determining the position of each selected option from the grid definition; and controlling the printer device to print a paper ballot containing a two dimensional grid with markings at each determined position corresponding to a voter selected option received from the voter.

In one embodiment, the grid positions assigned to the various options are identified by x-y coordinate positions on the grid. In another, simpler embodiment, each grid position may be assigned a value, for example sequential numerical or other values may be assigned to the grid positions going from top to bottom and left to right, and each sequential value is then assigned to a respective voter option in the grid definition.

The method may also comprise controlling the printer device to print tags on the ballot which identify the grid definition used to interpret the results, and reading or scanning the ballot to determine the voter selections and add the selections to a set of tabulated election results.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram illustrating one embodiment of a ballot system including components for populating and printing paper ballots

FIG. 2 illustrates a single ballot grid being interpreted into two distinct formats based on voter input and a ballot definition;

FIG. 3 is a flow diagram illustrating an example of a method or process for populating and printing paper ballots according to one embodiment; and

FIG. 4 is a block diagram illustrating an example computer system that may be used in connection with various embodiments described herein.

### DETAILED DESCRIPTION

Certain embodiments as disclosed herein provide for a system and method for populating and printing paper ballots which can be interpreted by a tabulation system with a scanner. For example, one method as disclosed herein allows for creating of a two dimensional grid definition in which each x, y position on the grid corresponds to a candidate or option in an election, and for converting a voter's selections of candidates or options into a series of positions marked on a two dimensional grid which can be printed on a paper ballot along with tags identifying the grid definition so that the results can be read and interpreted by a scanning device.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

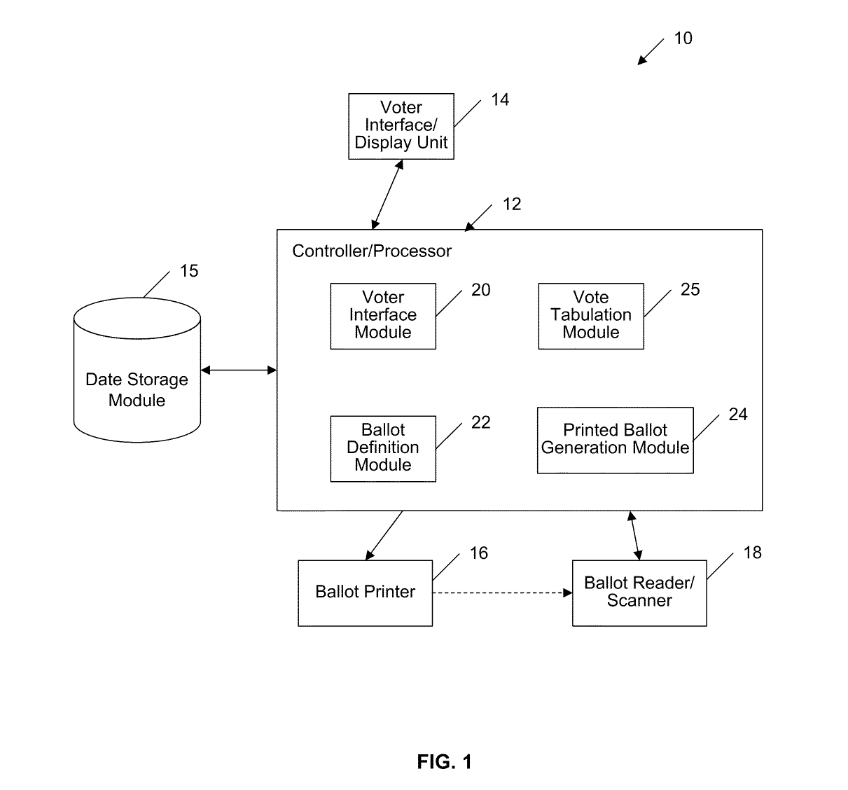

FIG. 1 illustrates one embodiment of a ballot system 10 in which paper ballots are populated and printed based on voters' selections from a list of ballot options and a two dimensional grid definition of the ballot options. In the illustrated embodiment, the system 10 comprises one or more processors or controllers, such as a controller or processor 12 and associated devices comprising a voter input device 14 such as a touch screen or the like, a data storage device 15, a ballot printer device 16, and a ballot reader or scanner device 18. The controller or processor 12 includes a voter interface module 20 which creates and controls the voter interface on the input device and receives user selections entered on the interface, a ballot definition module 22, a printed ballot generation module 24, and a vote tabulation module 25.

The voter input device 14 in the illustrated embodiment may comprise any electronic means of casting a vote, such as a touch screen which displays a graphical user interface (GUI) for receiving voter selections from a list of options such as candidates or alternative actions (such as yes or no choices to propositions and the like). Other types of voter input device may be used in alternative embodiments, such as audio input devices and optical scan voting systems. Device 14 may be communicatively coupled with processor 12 in any suitable manner, including local or remote connections via one or more wired or wireless networks such as mobile or telephone networks, public or private computer networks, or the Internet, with appropriate security systems for privacy purposes.

The ballot printer device 16 may be a commercially available printer and is also communicatively coupled with processor 12 via a wired or wireless network or the like. Printed ballot generation module controls the printer device 16 to print a ballot in a two dimensional grid showing the voter's selections as markings at pre-defined positions on the grid based on a grid definition created by ballot definition module 22, as described in more detail below. The printed ballot is designed to be readable by both human beings and by a computer system using a scanning device 18 which may include an OCR reader, bar code reader, and the like. The output of the scanning device 18 is provided to a vote tabulation module 25 which interprets the output based on the ballot definition to convert a mark at a grid position into a vote for the option or candidate corresponding to that two dimensional grid position. Data storage module 15 stores program instructions for the various processor modules, as well as tabulated votes, voter inputs, and ballot definitions. Different ballot definitions may be associated randomly with different voters for security purposes.

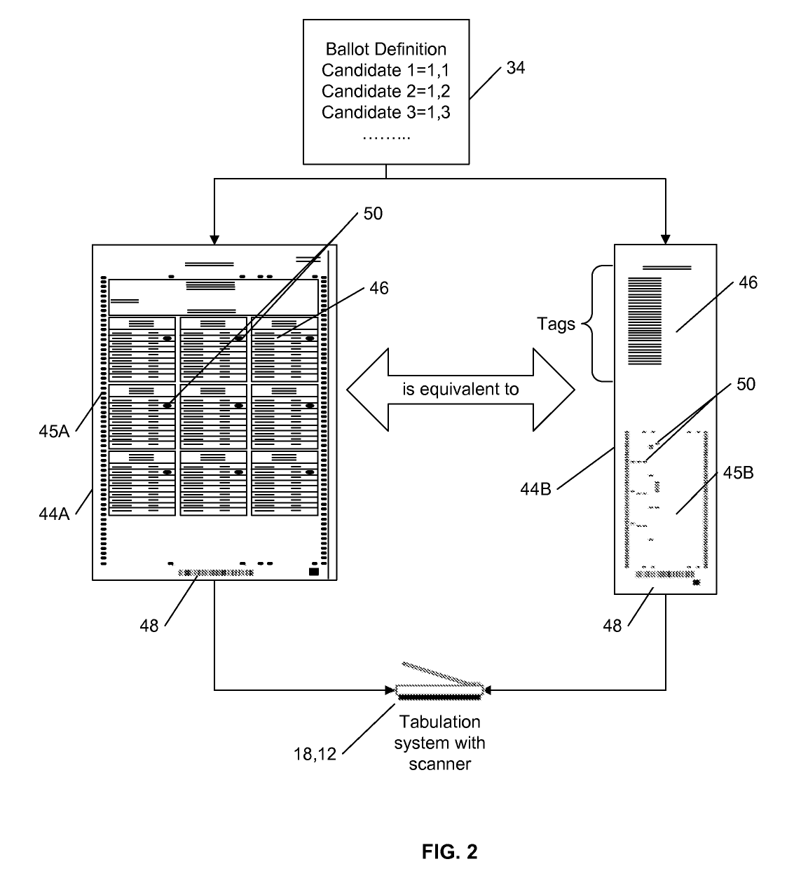

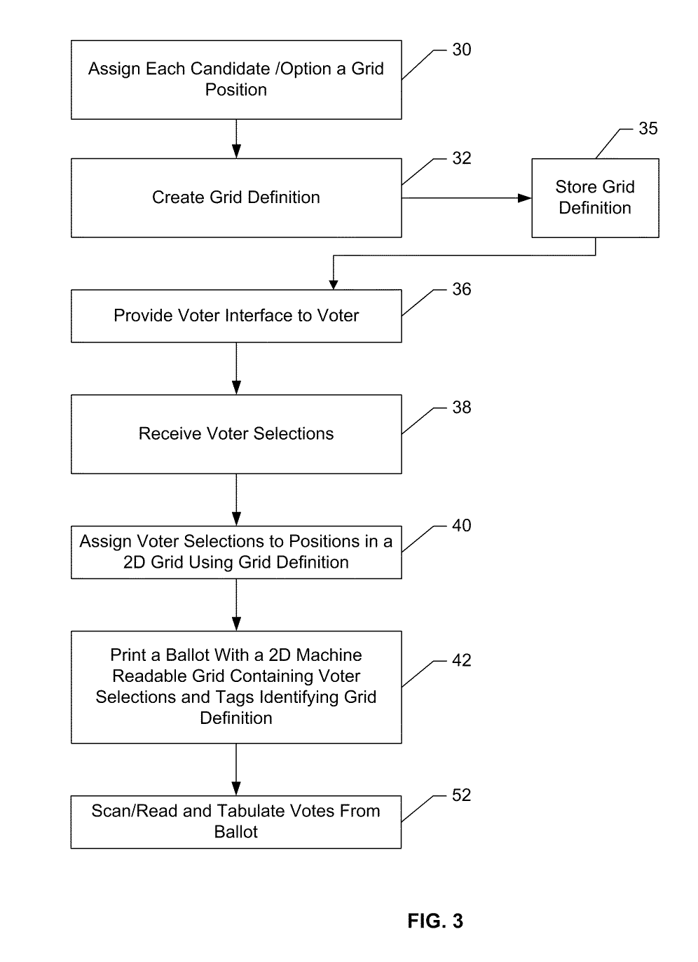

One embodiment of a method for populating and printing paper ballots using the system of FIG. 1 is illustrated in FIGS. 2 and 3. In step 30 of FIG. 3, each candidate or option in an election is assigned a physical position in a two dimensional or x-y grid, and a ballot definition is created from the assigned positions (step 32). For example, the ballot definition may be as follows:

### Candidate 1=1, 1

### Candidate 2=1, 2

Candidate 3=1, 3, and so on. This creates a ballot or grid definition 34 as illustrated in FIG. 2. Each x, y grid position in definition 34 comprises either a candidate or an option on a voting issue. The ballot or grid definition is stored in the data storage module or device 15 (step 35). In one embodiment, more than one ballot definition may be created, with different ballot or grid definitions being assigned randomly to different voter inputs. Alternatively, a single ballot definition may be used for all voters in combination with random presentations of selections to a voter, e.g., so the order of candidates can be randomly presented across all voters while the printed ballot format is the same. In one embodiment, different ballot definitions are associated with respective identification codes which may be provided in a barcode on the paper ballot to allow interpretation of the vote after scanning.

A voter interface listing the candidates and any other types of options for an election is then provided to a voter (step 36), and voter selections are received at voter interface module 20 (step 38). The voter selections are then assigned to points or x-y positions on a two dimensional grid based on the stored ballot or grid definition (step 40). For example, if a voter selects candidate 2 in the example above, a mark is assigned to the 1, 2 position on the grid. A ballot is then printed (step 42) in which the voter's selections are all marked at the appropriate x, y positions corresponding to the selected options on a two dimensional grid. The ballot also includes tags which identify which grid definition is to be used to interpret the results. The tags may comprise an actual ballot or grid definition, or a security or identification code which is associated with the ballot or grid definition in the data storage device. In one embodiment, the tags may also include other information such as a voter identification, polling station location, and the like.

FIG. 2 illustrates a single ballot grid being interpreted into two distinct formats or ballots 44A and 44B which can be interpreted equally by a tabulation system using a scanner such as scanning device 18 of FIG. 1. Each ballot includes a two dimensional grid 45A, 45B, respectively, with marks 50 at x, y positions corresponding to the voter selected options, as well as tags which identify the grid definition to be used to interpret the results. Although the grids on ballots 44A and 44B are on one side of the ballot, the grid 45A, 45B may extend from the front to the back of the paper in other embodiments. The tags can include, but are not limited to, text 46 which can be interpreted by optical character recognition (OCR) algorithms and barcodes 48. Barcodes 48 may contain information on the voter and/or precinct in addition to identifying the grid definition. Marks 50 are provided at predetermined x-y positions on each grid based on selections received from a voter and a predetermined ballot or grid definition 34. In the larger ballot 44A, the text 46 is in line with the two dimensional grid so that each mark 50 is next to the associated voting option or candidate. The smaller or narrower ballot 44B has a grid 45B which is completely separate from the text 46 which in this case simply lists the user's selections, unlike ballot 44A which lists all the voting categories and associated selections with a mark next to each user selection in each category.

Although the coordinate system used for the ballot definition in the foregoing embodiment is an x,y grid, the coordinate system or grid definition may be simplified in alternative embodiments by assigning a sequential value to each position on the grid, for example a count of positions starting at the upper left and going top to bottom and left to right for the full number of positions on the grid. In this case, each grid position is assigned to a single value, such as a numeric value.

Ballots may be printed single sided or duplex depending on the capabilities of the printer and the scanning system. Once scanned, the tabulation system can translate the marked ballots into valid candidate selection for reporting purposes (step 52), using the grid identification number on the barcode and the corresponding grid definition stored in data storage module 15.

The X and Y grid definition of the ballot provides a flexible and easily produced ballot which can be easily read by both human beings and computer systems. Additionally, the grid can be expanded to associate the marks 50 with the actual selection in text 46 next to the marked area, as illustrated in ballot 44A of FIG. 2, or compressed to a minimum size as illustrated in ballot 44B, with the actual selection in text spaced above the grid 45B. Ballot 44B reduces paper usage while still providing both human and machine readability. This system also allows the ballots to be read in a variety of formats simultaneously on a single device, including but not limited to 8.5 inch wide ballots as well as condensed 3.25 inch grids. The grid printing of the ballot can be easily and accurately produced by any number of commercially available printers without detriment to the scan ability of the data, while security constraints within the tag data or on the printed/electronic ballot can prevent unauthorized duplication.

The system and method described above provides a flexible and easily produced ballot which meets the requirements of legislation for recording or verifying a voter's selections while allowing a voter to enter their selections at any desired type of input device, including a touch screen display. The ballot includes both visual and machine readable data which can be easily read by both human beings and computer systems including reader or scanner devices, while avoiding inconsistencies resulting from hand marked ballots.

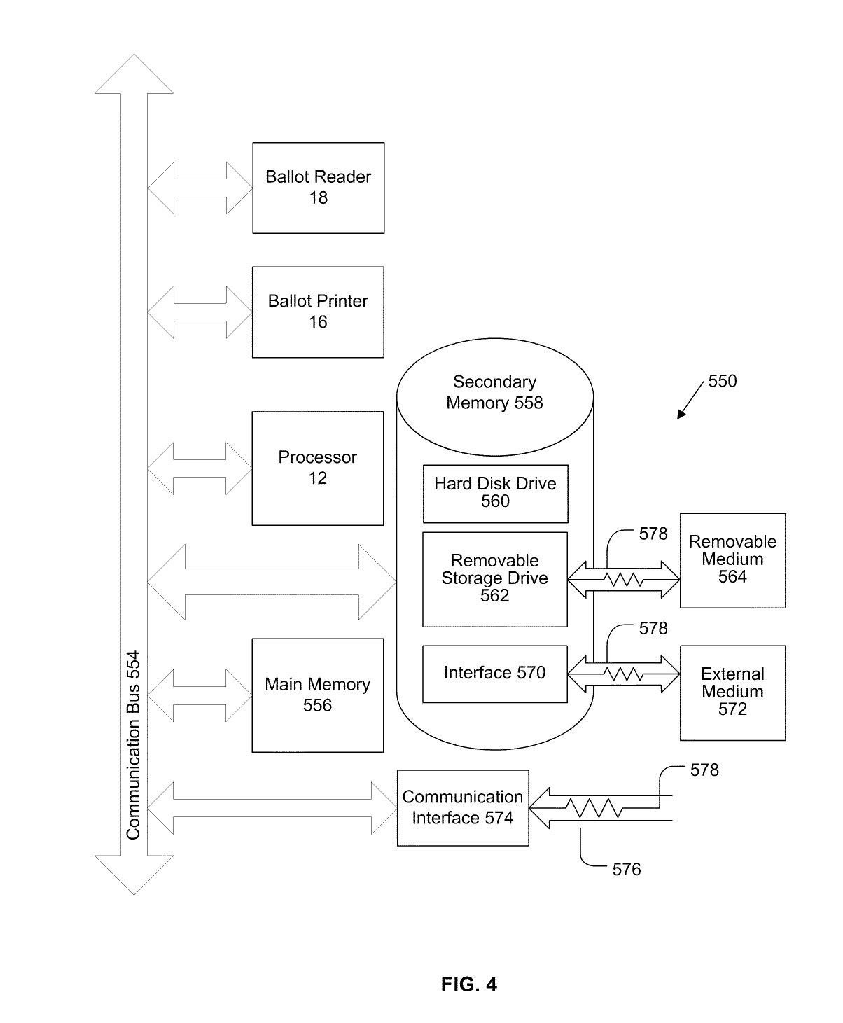

FIG. 4 is a block diagram illustrating an example of a computer system 550 that may be used in connection with various embodiments described herein. For example, the computer system 550 may be used in conjunction with a voting system arranged to populate and print paper ballots and to read data from the ballots in order to tabulate votes, as described above in connection with FIGS. 1 to 3. However, other computer systems and/or architectures may be used, as will be clear to those skilled in the art.

The computer system 550 preferably includes one or more processors, such as processor 12. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 12.

The processor 12 is connected to a communication bus 554. The communication bus 554 may include a data channel for facilitating information transfer between storage and other peripheral components of the computer system 550, including ballot printer 16 and ballot reader 18 as described above. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

The ballot reader 18 is designed to read the input from a populated paper ballot created by the system described above, such as ballot 44A or 44B, and transform it into a digital election image that can be transferred via the communication bus 554 to the storage and other peripheral components of the computer system 550. For example, the ballot reader 18 can scan the ballot and then report the grid positions of each mark 50 on the ballot as well as the grid definitions to the vote tabulation module 25 (FIG. 1), which then determines and tabulates the votes, and stores the votes in memory.

Computer system 550 includes a main memory 556 and may also include a secondary memory 558. The main memory 556 provides storage of instructions and data for programs executing on the processor 12. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a non-transitory computer readable medium having stored thereon computer executable code (i.e., software) and/or data, such as vote definitions, different ballot formats, and tabulated votes. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto- optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Voter interfaces may be transferred from computer system 550 to an external user device or display unit 14 via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any non-transitory media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a non-transitory computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of non- transitory storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A system for populating and printing paper ballots, the system comprising:
a computer readable storage device for storing computer executable programmed modules;
a processor communicatively coupled with the computer readable storage device for executing programmed modules stored therein;
a voter interface module stored in the computer readable storage device, the voter interface module configured to receive a voter selection of options on a voter interface;
a ballot definition module stored in the computer readable storage device and configured to create a ballot definition which associates each option on a ballot with a respective position on a grid; and
a printed ballot generation module stored in the computer readable storage device and configured to determine the position for each voter selected option received by the ballot definition module from a voter and to create a paper ballot having indicia comprising at least a two dimensional, machine readable grid with markings at the determined positions on the grid corresponding to the voter selected options received at the voter interface module.

2. The system of claim 1, wherein the indicia on the paper ballot further comprise tags which identify the grid definition used to create the marked grid.

3. The system of claim 1, wherein a sequential value is assigned to each position on the grid and each option on the ballot is assigned to a respective one of the sequential values.

4. The system of claim 1, wherein an x-y coordinate position on the grid is assigned to each ballot option.

5. A system comprising at least one processor communicatively coupled with at least one memory and at least one printer device, wherein the processor is programmed to populate and print paper ballots on the printer device by:
assigning each option of a series of voter selectable options with a respective position on a two dimensional grid;
creating a grid definition comprising a list of the voter selectable options and the associated positions on the grid;
storing the grid definition in the memory;
receiving data from a voter comprising a selection of options from a list of voter selectable options;
determining the position of each selected option from the grid definition; and
controlling the printer device to print a paper ballot containing a two dimensional grid with markings at each determined position corresponding to a voter selected option received from the voter.

6. A computer implemented method for populating and printing paper ballots, where one or more processors are associated with at least one memory and are programmed to perform steps comprising:
assigning each option of a series of voter selectable options with a respective position on a two dimensional grid;
creating a grid definition comprising a list of the voter selectable options and the associated positions;
storing the grid definition in the memory;
receiving data from a voter comprising a selection of options from a list of voter selectable options;
determining the position of each selected option from the grid definition; and
controlling the printer device to print a paper ballot containing a two dimensional grid with markings at each determined position corresponding to a voter selected option received from the voter.

7. A non-transitory computer readable medium having stored thereon one or more sequences of instructions for causing one or more microprocessors to perform the steps for populating and printing paper ballots, the steps comprising:
assigning each option of a series of voter selectable options with a respective position on a two dimensional grid;
creating a grid definition comprising a list of the voter selectable options and the associated positions;
storing the grid definition on the computer readable storage medium;
receiving data from a voter comprising a selection of options from a list of voter selectable options;
determining the position of each selected option from the stored grid definition; and
controlling the printer device to print a paper ballot containing a two dimensional grid with markings at each determined position corresponding to a voter selected option received from the voter.
